(19) United States
(12) Patent Application Publication
(10) Pub. No.: US 2026/0161126 A1
(43) Pub. Date: Jun. 11, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Junya YAMADA, Kanagawa (JP)

(73) Assignee: FUJIFILM Business Innovation Corp., Tokyo (JP)

(21) Appl. No.: 19/187,163

(22) Filed: Apr. 23, 2025

(30) Foreign Application Priority Data
Dec. 5, 2024 (JP) 2024-212477

(51) Int. Cl. G03G 15/00

(52) U.S. Cl. CPC G03G 15/553

(57) ABSTRACT

An information processing system includes a processor configured to acquire and record, for each unit of a management target apparatus, management information for managing a remaining life of the unit, the management information including remaining life determination information for determining a remaining life of each component in the unit.

### CROSS-REFERENCE TO RELATED APPLICATIONS

This application is based on and claims priority under 35 USC 119 from Japanese Patent Application No. 2024-212477 filed December 5, 2024.

### BACKGROUND

### (i) Technical Field

The present disclosure relates to an information processing system and a non-transitory computer readable medium.

### (ii) Related Art

Japanese Unexamined Patent Application Publication No. 2005-339168 describes a recycling processing system in which when units or components of apparatus products are compatible with each other, the units or components are configured to be replaceable, and the apparatus products are collectively managed, thereby improving the reusability of the units or components of the apparatus products.

### SUMMARY

For example, in an apparatus such as a multifunction peripheral, a unit that is a part of the apparatus may be reused. In this case, usage history information is acquired for each unit, and a unit whose remaining life does not satisfy a criterion is not reused.

However, when maintenance is performed for some of the components in a unit, the remaining life of the unit may change, making it difficult to accurately determine the unit's reusability based on the unit's usage history information.

Aspects of non-limiting embodiments of the present disclosure relate to an information processing system and a non-transitory computer-readable storage medium storing a program enabling accurate determination on the reusability of a unit even when maintenance is performed for some of the components in the unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to acquire and record, for each unit of a management target apparatus, management information for managing a remaining life of the unit, the management information including remaining life determination information for determining a remaining life of each component in the unit.

### BRIEF DESCRIPTION OF THE DRAWINGS

Exemplary embodiments of the present disclosure will be described in detail based on the following figures, wherein:

FIG. 1 is a diagram illustrating a system configuration of an image forming apparatus management system according to an exemplary embodiment of the present disclosure;

FIG. 2 is a block diagram illustrating a hardware configuration of a management server according to an exemplary embodiment of the present disclosure;

FIG. 3 is a block diagram illustrating a hardware configuration of an image forming apparatus according to an exemplary embodiment of the present disclosure;

FIG. 4 is a diagram illustrating an example of management information for an automatic duplex document feeder unit of the image forming apparatus;

FIG. 5 is a diagram illustrating how the management information for the automatic duplex document feeder unit of the image forming apparatus is updated;

FIG. 6 is a flowchart illustrating a flow of processing in the image forming apparatus;

FIG. 7 is a flowchart illustrating a flow of processing in the image forming apparatus;

FIG. 8 is a flowchart illustrating a flow of processing in the image forming apparatus;

FIG. 9 is a flowchart illustrating a flow of processing in a management server;

FIG. 10 is a flowchart illustrating a flow of processing in a terminal owned by a maintenance personnel; and

FIG. 11 is a flowchart illustrating a flow of processing in the management server.

### DETAILED DESCRIPTION

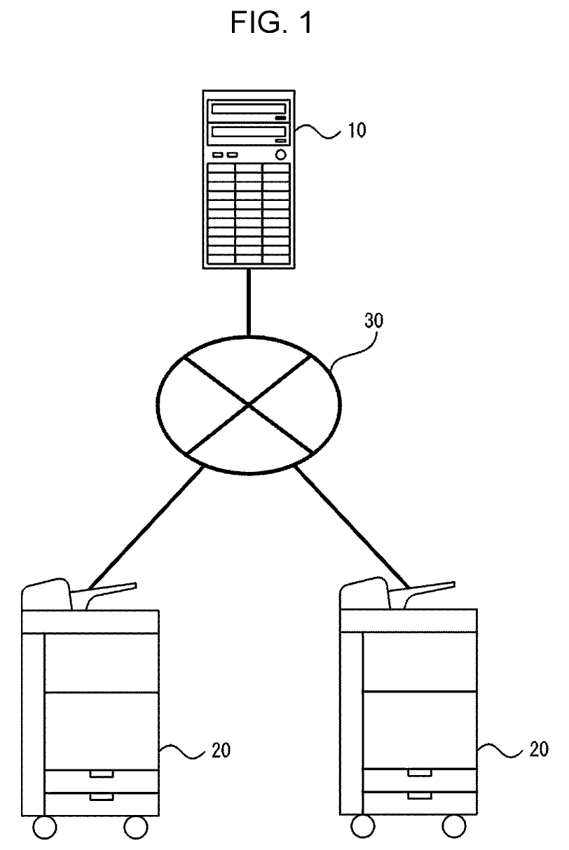

Exemplary embodiments for implementing the technique of the present disclosure will be described below in detail with reference to the drawings. FIG. 1 is a diagram illustrating a system configuration of an image forming apparatus management system according to an exemplary embodiment.

As illustrated in FIG. 1, the image forming apparatus management system according to the present exemplary embodiment includes a management server 10 and a plurality of image forming apparatuses 20. In this image forming apparatus management system, the management server 10 acquires usage history information for each unit that is a part of the image forming apparatus 20 so that the unit can be reused.

The management server 10 is a server for acquiring and managing information on the usage history of each unit of the image forming apparatus 20. The management server 10 is an example of an information processing system according to the technique of the present disclosure.

The image forming apparatus 20 is a so-called multifunction peripheral having a plurality of functions such as a copy function, a print function, a facsimile function, and a scan function. The image forming apparatus 20 includes a plurality of units such as an automatic duplex document feeder unit, an image reading unit, and an image forming unit, for example. The image forming apparatus 20 is connected to the management server 10 via the Internet 30. The image forming apparatus 20 is an example of a management target apparatus according to the technique of the present disclosure.

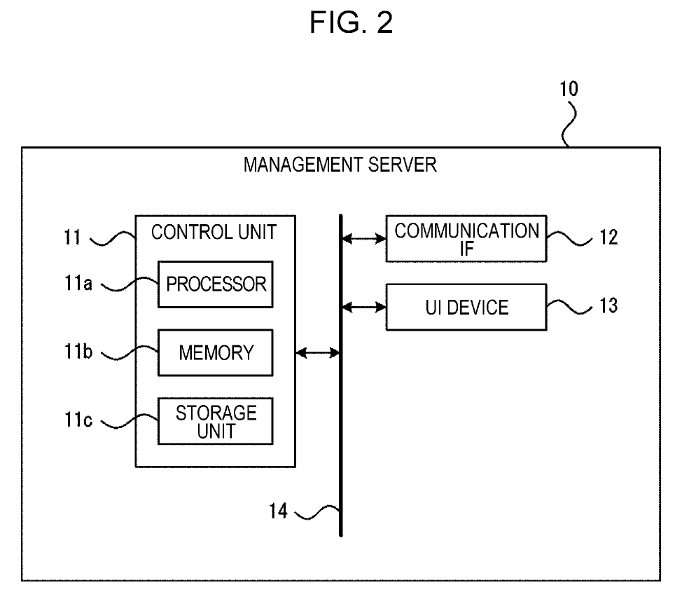

Next, a hardware configuration of the management server 10 of the present exemplary embodiment will be described. FIG. 2 is a block diagram illustrating the hardware configuration of the management server 10.

As illustrated in FIG. 2, the management server 10 includes a control unit 11, a communication interface (hereinafter abbreviated as "communication IF") 12, and a user interface device (hereinafter abbreviated as "UI device") 13. These components are connected to each other via a control bus 14.

The control unit 11 includes a processor 11a, a memory 11b, and a storage unit 11c. The processor 11a executes predetermined processing based on a program read from the storage unit 11c and loaded into the memory 11b. The storage unit 11c includes, for example, a read only memory (ROM), a hard disk drive (HDD), a solid state drive (SSD), or the like. Various programs, data, and the like are stored in the storage unit 11c.

While the present exemplary embodiment relates to a case where the processor 11a reads out and executes a program stored in the storage unit 11c, the present disclosure is not limited to this. The program may be provided in a form recorded in a computer-readable recording medium as described above. Alternatively, the program may be acquired from an external apparatus via a communication line.

The communication IF 12 performs data transmission and reception with an external apparatus or the like. The UI device 13 is a device for a user to input information, such as a mouse and/or a keyboard, for example.

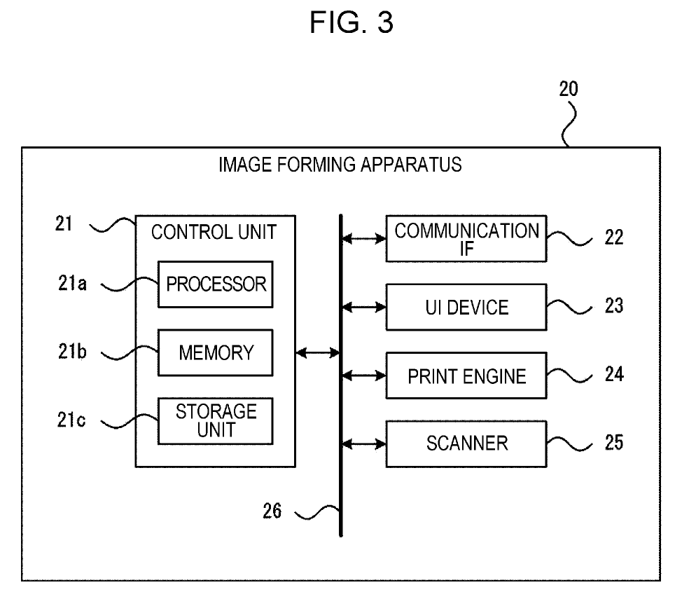

Next, a hardware configuration of the image forming apparatus 20 according to the present exemplary embodiment will be described. FIG. 3 is a block diagram illustrating the hardware configuration of the image forming apparatus 20.

As illustrated in FIG. 3, the image forming apparatus 20 includes a control unit 21, a communication IF 22, a UI device 23, a print engine 24, and a scanner 25. These components are connected to each other via a control bus 26.

The control unit 21 includes a processor 21a, a memory 21b, and a storage unit 21c. The processor 21a executes predetermined processing based on a program read from the storage unit 21c and loaded into the memory 21b. The storage unit 21c includes, for example, a ROM, an HDD, an SSD, or the like. Various programs, data, and the like are stored in the storage unit 21c.

While the present exemplary embodiment relates to a case where the processor 21a reads out and executes a program stored in the storage unit 21c, the present disclosure is not limited to this. The program may be provided in a form recorded in a computer-readable recording medium as described above. Alternatively, the program may be acquired from an external apparatus via a communication line.

The communication IF 22 performs data transmission and reception with an external apparatus or the like. The UI device 23 is a device for a user to receive or input information, such as a touch panel and/or a button, for example. The print engine 24 prints an image on a recording medium, such as a printing sheet, through processes such as charging, exposure, development, transfer, and fixing. The scanner 25 reads a document loaded in the image forming apparatus 20 as image data.

As described above, in the image forming apparatus management system of the present exemplary embodiment, the management server 10 acquires usage history information for each unit that is a part of the image forming apparatus 20 so that the unit can be reused.

However, when maintenance is performed for some of the components in a unit, the remaining life of the unit may change, making it difficult to accurately determine the unit's reusability based on the unit's usage history information.

In order to solve such a problem, the control unit 11 of the management server 10 according to the present exemplary embodiment acquires and records management information for managing the remaining life of each unit of the image forming apparatus 20. The management information also includes remaining life determination information for determining the remaining life of each component in the unit.

The remaining life of a unit is most affected by a component having the shortest remaining life among the components in the unit. Thus, through recognition of the remaining life of each component, the reusability of the unit can be accurately determined.

In the image forming apparatus management system according to the present exemplary embodiment, the remaining life determination information may be a cumulative value indicating the usage history of a component. Here, the "cumulative value indicating the usage history" is, for example, a value representing the usage count of a component, the usage time of a component, or the like.

The cumulative value may be a value proportional to the usage count of a component or the usage time of a component. The "value proportional to the usage count of a component or the usage time of a component" may be the value itself of the usage count of a component or the usage time of a component, or may be a value proportional to the usage count of a component or the usage time of a component such as, for example, a value that is incremented by 1 every 100 usage counts of the component or a value that is incremented by 1 every time 100 hours elapses as the usage time of the component.

The control unit 11 of the management server 10 may acquire the cumulative value itself indicating the usage history from the image forming apparatus 20. The control unit 11 of the management server 10 may acquire from the image forming apparatus 20, a value of difference in the cumulative value, indicating the usage history, from the immediately preceding value acquired, and calculate the cumulative value.

The remaining life determination information may be information on the usage start date of a component.

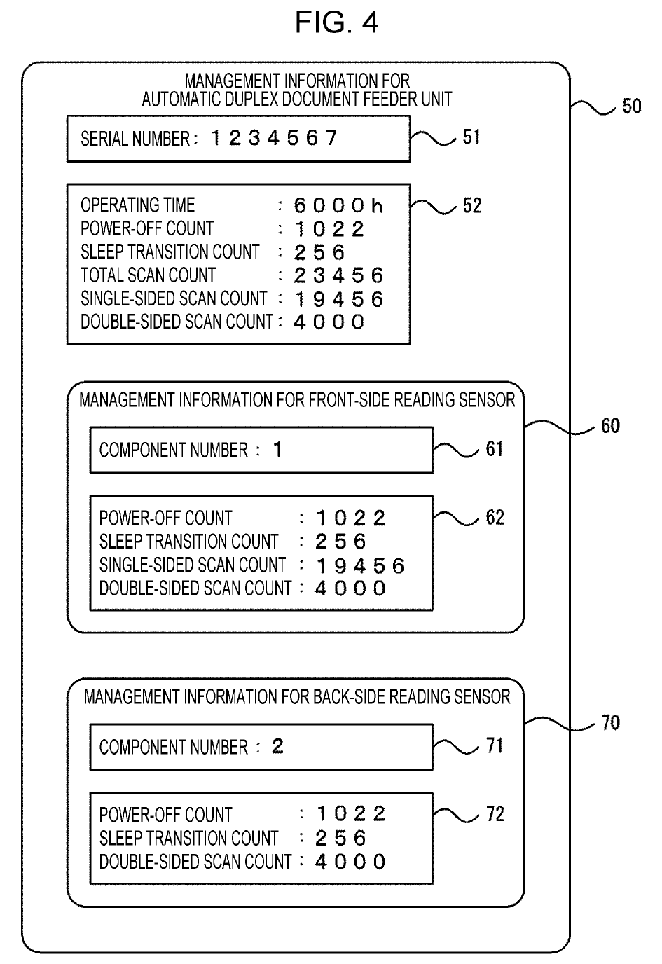

The management information acquired by the management server 10 will be described below. Here, by way of example, management information for the automatic duplex document feeder unit will be described. The automatic duplex document feeder unit includes a front-side reading sensor and a back-side reading sensor as components in the unit. FIG. 4 is a diagram illustrating an example of management information 50 of the automatic duplex document feeder unit.

As illustrated in FIG. 4, the management information 50 of the automatic duplex document feeder unit includes a serial number 51 serving as unit identification information for the unit, remaining life determination information 52 of the automatic duplex document feeder unit, management information 60 of the front-side reading sensor, and management information 70 of the back-side reading sensor.

The remaining life determination information 52 of the automatic duplex document feeder unit is, for example, history information indicating a usage history and includes information such as operating time, power-off count, sleep transition count, total scan count, single-sided scan count, and double-sided scan count.

The management information 60 of the front-side reading sensor includes a component number 61 serving as identification information for the component and remaining life determination information 62 of the front-side reading sensor. The remaining life determination information 62 of the front-side reading sensor is, for example, history information indicating a usage history and includes information such as power-off count, sleep transition count, single-sided scan count, and double-sided scan count.

The management information 70 of the back-side reading sensor includes a component number 71 serving as identification information for the component and remaining life determination information 72 of the back-side reading sensor. The remaining life determination information 72 of the back-side reading sensor is, for example, history information indicating a usage history and includes information such as power-off count, sleep transition count, and double-sided scan count.

In response to maintenance of a component in a unit, upon acquiring management information for the unit with the component after the maintenance, the control unit 11 may update the remaining life determination information for the component after the maintenance.

Here, "maintenance of a component" includes both replacement with a new component and repairing of a component.

When the remaining life determination information is the cumulative value indicating the usage history of a component, "update the remaining life determination information" means updating the cumulative value. The updating of the cumulative value is not necessarily limited to zeroing the cumulative value. For example, the cumulative value may be zeroed when the component is replaced, reduced when the component is repaired, or the like.

When the remaining life determination information is the information on the usage start date of a component, "update the remaining life determination information" means inputting a maintenance date.

When updating the remaining life determination information for a component after the maintenance, the control unit 11 may acquire management information for a unit with the component after the maintenance from the image forming apparatus 20 or from a terminal owned by a maintenance personnel for the image forming apparatus 20.

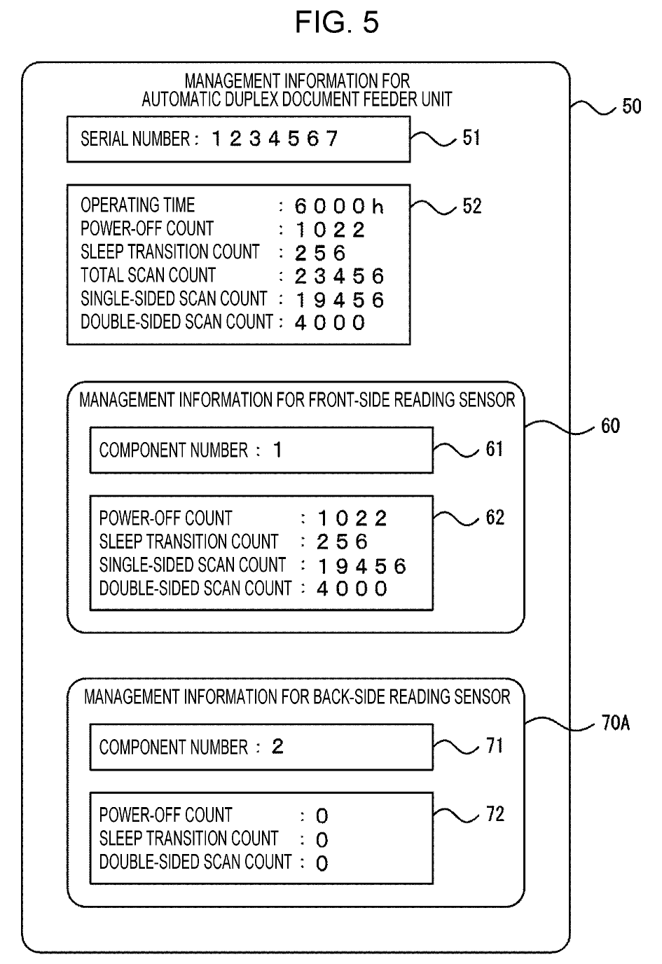

Hereinafter, updating of the remaining life determination information on a component after maintenance will be described. Updating of the management information 50 of the automatic duplex document feeder unit will be described by way of example. FIG. 5 is a diagram illustrating the updating of the management information 50 of the automatic duplex document feeder unit.

For example, when the back-side reading sensor is maintained, as illustrated in FIG. 5, the control unit 11 acquires and updates management information 70A of the new back-side reading sensor. With the updated management information 70A, the power-off count, the sleep transition count, and the double-sided scan count in the remaining life determination information 72 are updated to zero.

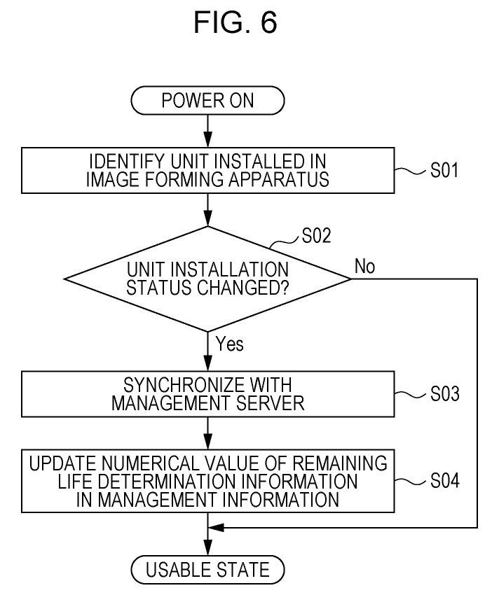

Next, a flow of processing executed by each apparatus included in the image forming apparatus management system will be described with reference to flowcharts in FIGS. 6 to 11.

As illustrated in FIG. 6, when the image forming apparatus 20 is powered on, the control unit 21 of the image forming apparatus 20 identifies, in step S01, a unit installed in the image forming apparatus 20.

Next, in step S02, the control unit 21 determines whether the installation status of the unit has been changed.

Upon determining in step S02 that the installation status of the unit has been changed, in step S03, the control unit 21 connects to the management server 10, synchronizes the management information for the unit recorded in the image forming apparatus 20 with the management information for the unit recorded in the management server 10, and in step S04, updates the numerical value of the remaining life determination information in the management information, and causes the image forming apparatus 20 to transition to a usable state.

Upon determining in step S02 that the unit installation status has not been changed, the control unit 21 causes the image forming apparatus 20 to transition to the usable state.

Upon causing the image forming apparatus 20 to transition to the usable state, the control unit 21 updates the numerical value of the counter for measuring a change in the numerical value of the remaining life determination information to zero.

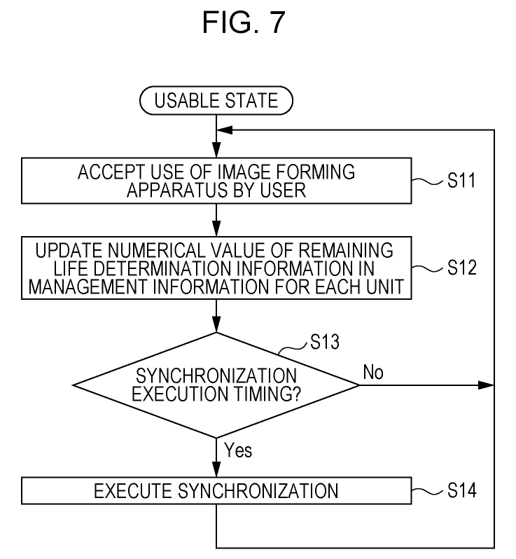

As illustrated in FIG. 7, with the image forming apparatus 20 being in the usable state, in step S11, the control unit 21 of the image forming apparatus 20 accepts the use of the image forming apparatus 20 by the user, and in step S12, updates the numerical value of the remaining life determination information in the management information for each unit.

Next, in step S13, the control unit 21 determines whether the synchronization execution timing has arrived.

Upon determining in step S13 that the synchronization execution timing has arrived, in step S14, the control unit 21 executes synchronization with the management server 10, and then proceeds to step S11.

Upon determining in step S13 that the synchronization execution timing has not arrived yet, the control unit 21 directly proceeds to step S11.

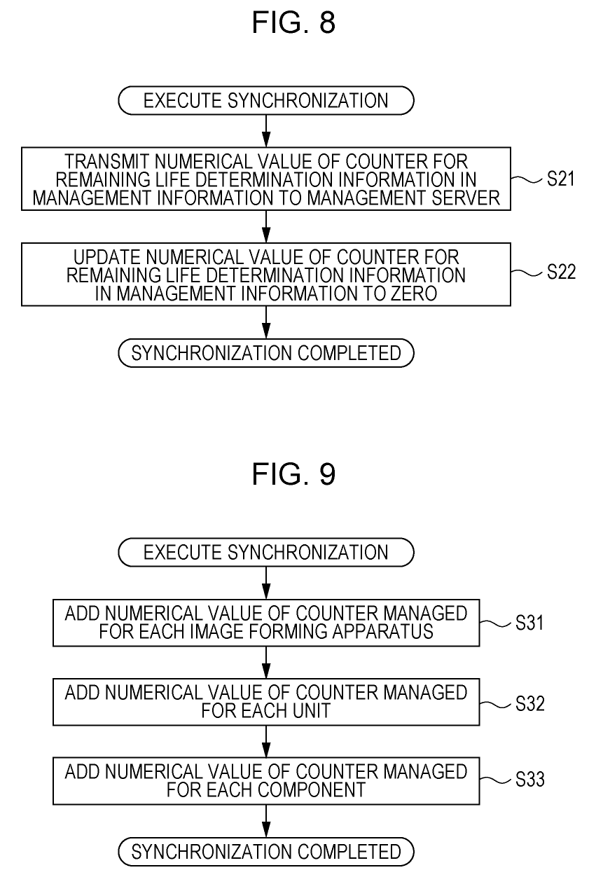

As illustrated in FIG. 8, when the image forming apparatus 20 executes the synchronization with the management server 10, in step S21, the control unit 21 of the image forming apparatus 20 transmits the numerical value of the counter for the remaining life determination information in the management information to the management server 10, and then, in step S22, updates the numerical value of the counter for the remaining life determination information in the management information to zero. Thus, the synchronization is completed.

As illustrated in FIG. 9, when the management server 10 executes synchronization with the image forming apparatus 20, in step S31, the control unit 11 of the management server 10 adds the numerical value of the counter managed for each image forming apparatus.

Next, in step S32, the control unit 11 adds the numerical value of the counter managed for each unit.

Next, in step S33, the control unit 11 adds the numerical value of the counter managed for each component. Thus, the synchronization is completed.

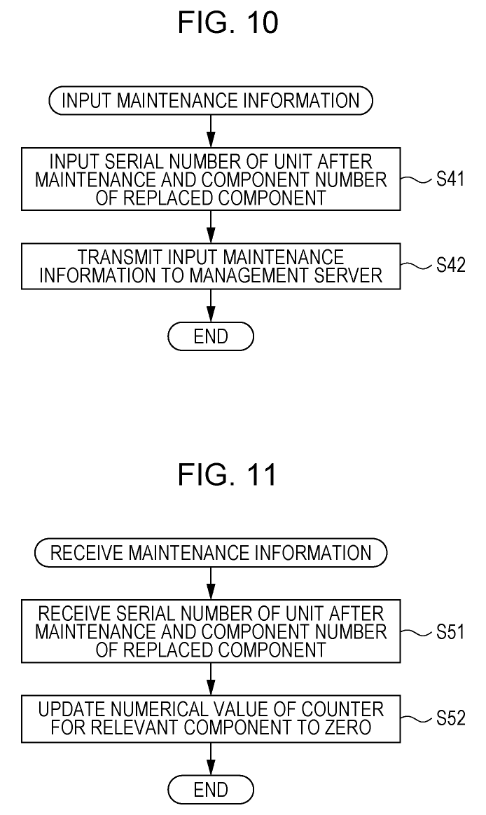

As illustrated in FIG. 10, when maintenance is performed for a component in a unit of the image forming apparatus 20, the maintenance personnel for the image forming apparatus 20 inputs maintenance information from a terminal he or she owns.

First of all, the maintenance personnel inputs the serial number of the unit after the maintenance and the component number of the replaced component as the maintenance information in step S41, and transmits the input maintenance information to the management server in step S42.

As illustrated in FIG. 11, upon receiving the serial number of the unit after the maintenance and the component number of the replaced component as the maintenance information in step S51, the control unit 11 of the management server 10 updates the numerical value of the counter for the relevant component in the relevant unit to zero in step S52.

### [Modifications]

While the information processing system according to an exemplary embodiment of the present disclosure has been described above, the technique of the present disclosure is not limited to the above-described exemplary embodiment and can be appropriately modified.

In the embodiments above, the term "processor" refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term "processor" is broad enough to encompass one processor or plural processors in collaboration which are located physically apart from each other but may work cooperatively. The order of operations of the processor is not limited to one described in the embodiments above, and may be changed.

The "system" according to the technique of the present disclosure includes both a system configured by a plurality of apparatuses and a system configured by a single apparatus.

Furthermore, the technique of the present disclosure can also be applied to a program and a program product.

### Appendix

### (((1)))

An information processing system comprising a processor configured to:

acquire and record, for each unit of a management target apparatus, management information for managing a remaining life of the unit,

the management information including:

remaining life determination information for determining a remaining life of each component in the unit.

### (((2)))

The information processing system according to (((1))), wherein the remaining life determination information is a cumulative value indicating a usage history of the component.

### (((3)))

The information processing system according to (((2))), wherein the cumulative value is a value proportional to a usage count of the component or a usage time of the component.

### (((4)))

The information processing system according to (((1))), wherein the remaining life determination information is information on a usage start date of the component.

### (((5)))

The information processing system according to any one of (((1))) to (((4))), wherein in response to maintenance of a component in a unit, upon acquiring the management information for the unit with the component after the maintenance, the processor is configured to update the remaining life determination information for the component after the maintenance.

### (((6)))

The information processing system according to (((5))), wherein the processor is configured to acquire the management information for the unit with the component after the maintenance from an apparatus including the unit.

### (((7)))

The information processing system according to (((5))), wherein the processor is configured to acquire the management information for the unit with the component after the maintenance, from a terminal owned by a maintenance personnel for the apparatus including the unit.

### (((8)))

A program causing a computer to execute a process comprising acquiring and recording, for each unit of a management target apparatus, management information for managing a remaining life of the unit,

the management information including:

identification information for each component in the unit; and

remaining life determination information for determining a remaining life of each component in the unit.

What is claimed is:

1. An information processing system comprising:
a processor configured to:
acquire and record, for each unit of a management target apparatus, management information for managing a remaining life of the unit,
the management information including:
remaining life determination information for determining a remaining life of each component in the unit.

2. The information processing system according to claim 1, wherein the remaining life determination information is a cumulative value indicating a usage history of the component.

3. The information processing system according to claim 2, wherein the cumulative value is a value proportional to a usage count of the component or a usage time of the component.

4. The information processing system according to claim 1, wherein the remaining life determination information is information on a usage start date of the component.

5. The information processing system according to claim 1, wherein in response to maintenance of a component in a unit, upon acquiring the management information for the unit with the component after the maintenance, the processor is configured to update the remaining life determination information for the component after the maintenance.

6. The information processing system according to claim 5, wherein the processor is configured to acquire the management information for the unit with the component after the maintenance from an apparatus including the unit.

7. The information processing system according to claim 5, wherein the processor is configured to acquire the management information for the unit with the component after the maintenance, from a terminal owned by a maintenance personnel for the apparatus including the unit.

8. A non-transitory computer readable medium storing a program causing a computer to execute a process comprising acquiring and recording, for each unit of a management target apparatus, management information for managing a remaining life of the unit,
the management information including:
identification information for each component in the unit; and
remaining life determination information for determining a remaining life of each component in the unit.
